(19) United States
(12) Patent Application Publication
(10) Pub. No.: US 2024/0095864 A1
(43) Pub. Date: Mar. 21, 2024

(54) Blockchain-Enabled Non-Fungible Token (NFT) Application in Public Transit

(71) Applicant: Oliver B.M. Garcia, Monterey Park, CA (US)

(72) Inventor: Oliver B.M. Garcia, Monterey Park, CA (US)

(21) Appl. No.: 17/932,460

(22) Filed: Sep. 15, 2022

(51) Int. Cl. G06Q 50/30; G06Q 40/04

(52) U.S. Cl. CPC G06Q 50/30; G06Q 40/04

(57) ABSTRACT

A method is disclosed where a public blockchain is used to set up an operation to distribute digital fare tokens for providing transportation to consumers. Fare tokens are created electronically using a non-fungible token (NFT) system of algorithms running in the blockchain and change hands through internet-connected computing devices. Moreover, fare token production is designed to be capable of external sourcing, and the fare token itself is designed to re-circulate after being redeemed by a transportation consumer for service.

### CROSS-REFERENCE TO RELATED APPLICATIONS

This application claims the benefit of provisional patent application Ser. No. 63/473,492, filed 2022 Jun. 2 by the present inventor.

### BACKGROUND—PRIOR ART

The following is a tabulation of some prior art that presently appears relevant:

Nonpatent Literature Documents

U.S. Patents

| Patent Number | Kind Code | Issue Date | Patentee |
|---|---|---|---|
| 11,212,100 | B2 | 2021 Dec. 28 | Sharpe et al. |
| 11,348,099 | B2 | 2022 May 31 | Vijayan |

U.S. Patent Application Publications

| Patent Number | Kind Code | Publ. Date | Applicant |
|---|---|---|---|
| 20220198418 | A1 | 2022 Jun. 23 | Kang et al. |

International Association of Public Transport (UITP), “Demystifying Ticketing and Payment in Public Transport” (November 2020)

Https://nextcity.org/urbanist-newsgare-cost-ride-california-bullet-train, “How Much Will It Cost to Ride California's Bullet Train?” (May 12, 2015)

Https://www.inputmag.com/design/nyc-metrocard-notorious-big-50th-birthday, “NYC's new limited-edition MetroCard celebrates Notorious B.I.G.'s 50th birthday” (May 19, 2022)

Transit tokens have been widely used in public transit fare operations. They were usually made of round metal in the shape of coins. They were sold to transportation consumers and used as payment for train, “subway” or bus ride. The transit agency (or transportation provider) determines a transit zone of limited distance that one token allows a consumer to travel. The token is recovered by the transit agent from the consumer upon boarding the vehicle. It is subsequently available again for the transit agency to sell.

The physical tokens created for a transit agency usually came from a single source or manufacturer that designed and mass-produced them. Each token was identically designed to have a security feature built in the token's physical properties such that only the token of that particular set of properties (such as material, shape, weight, etc.) was valid as payment for service from a particular transit agency. Additionally, these same properties made up a basic deterrent for counterfeiting and unauthorized duplication.

The tokens themselves were officially maintained as property of the transit agency, and possession by a consumer only represented pre-payment of a fare. There were significant costs to the agency in managing these physical tokens, as they were not completely counterfeit-proof and were susceptible to material wear and tear. Furthermore, there were costs to installing and maintaining the mechanical token receivers. At the token's end-of-life, there were energy costs to destroying them, usually by melting them down as scrap metals.

Additionally, the physical tokens tended to get soiled and misplaced due to handling by consumers. As such, there could pose unhygienic conditions and public health risks with circulating tokens that might be laden with disease-causing germs.

Prior art paper tickets have also been used in public transportation. They are issued to consumers upon payment of fare, and are usually valid only within a duration of the date specified on the ticket. The tickets tended to circulate and generate revenue only if the transit zone is in service. Transit zones occasionally shut down for maintenance or repair, generally resulting in reduced revenue for the transit agency. Additionally, the transit agency solely makes significant initial investments on the design and development of tokens and tickets together with the fare infrastructure, usually in-house or by one contract signed with a single source company. This means for entirely new public transit lines under development such as California High-Speed Rail, the consideration of a ticketing system may be pushed far along the development phase. Studies are already available estimating how much a ticket or token will cost a consumer to access a ride with California High-Speed Rail. Even though the boarding stations making up the transit zones have long been planned, they may still be under construction, the fare operation is not yet implemented and is therefore not yet generating revenue for the agency.

As referenced in U.S. Pat. No. 11,212,100 (2021) to Sharpe et al., and U.S. Pat. No. 11,348,099 (2022) to Vijayan, digital tickets and tokens have been introduced and utilized for granting access to services or live events. Although the described systems might be implemented in a public transportation setting, they generated revenue only for established systems with existing consumer demand. The tickets or tokens were being developed by one creator, generally a single large, established franchise solely for delivery of its own good or service. Moreover, the digital tickets or tokens were operated as single-use and expired past completion of a single, specific live event, or past a valid-thru date. In another relevant U.S. patent application 2022/0198418 by Kang et al., to discourage profitable activity in secondary markets (e.g. resellers or “scalpers”), the described implementations were such that tokens and tickets were designed to hold limited resale value. An innovative, modernized transportation fare method is needed that would benefit transit systems, especially emerging ones, thriving local artists and small business owners, and any owner of the digital fare token.

### SUMMARY

Accordingly, similar features of the metal coin tokens and their associated fare infrastructure can be implemented in a demand-inducing, revenue-generating way with contactless, digital, non-fungible tokens (“NFT”) having enhanced security, lesser cost and minimal carbon footprint. The digital fare tokens change hands through internet-connected computing devices. As a security feature, the fare tokens indicate their producer, which can be readily and efficiently verified as whether authorized for use by the transit agency. In addition, if created out of an electronic distributed ledger such as a public blockchain, the mass production of fare tokens can be externally sourced and is not limited to a single source or creator. Any independent artist or business can produce them as long as they are authorized by the transit agency. A producer can embed a unique digital composition on the token which may be an artwork, a brand, or promotion of the producer's primary business to induce a social following. Finally, if designed as a non-expiring fare token in a public blockchain, a transit agency can resell the tokens upon recovery, in much the same way the prior art physical fare tokens are re-circulated.

### Advantages

The emerging technologies of blockchain and non-fungible token (NFT) are finding an ever-increasing cases of adoption and application. An existing internet platform such as that by company OpenSea.io that has been developed primarily to exchange digital artwork and similar digital assets, is well-suited for creating and distributing access “tokens”, or “tickets”. Specifically, such platforms readily lend themselves to a new and innovative fare operation for transportation agencies with minimal investment on implementation. This is especially potentially impactful for new, developing public transit rail systems such as the California High-Speed Rail Authority (CaHSRA), where funding various aspects of the project are in constant negotiation with public and corporate entities with scarce financial resources. Even for CaHSRA's planned transit zones where services do not yet exist, CaHSRA can create and sell fare tokens to the public, in anticipation of high-speed travel between far-flung cities in California by bullet train. Depending upon the social following and demand it induces, this innovative fare operation can be a viable source of funding to complement CaHSRA's capital infusions. The fare operation can continue to support the public transit system after it is fully constructed, due to the advantageous features of blockchain and NFT technologies.

### BRIEF DESCRIPTION OF THE DRAWINGS

FIG. 1 shows an example digital fare token as produced and accessed on a screen interface of a laptop or mobile computing device in accordance with the present invention.

FIG. 2 shows the fare token distribution and circulation among computer-based trading accounts of the token producers, sellers and buyers linked to a public blockchain.

FIG. 3 shows redemption of the digital fare token by a transportation consumer upon boarding the vehicle of a transit zone.

### DRAWINGS—REFERENCE NUMERALS

10 computing device with screen displaying a digital fare token
12 digital composition
14 fare token collection name
16 name of transit zone
18 fare token owner name
20 fare token price in cryptocurrency and fiat units
22 transfer touchscreen button
24 sell touchscreen button
26 buy touchscreen button
28 statement of fare token redemption terms
29 creator or producer name
30 providing link between trading accounts by public blockchain (sub-operation)
31 fare token producer's trading account and “wallet” accessed by computing device
32 other creators' trading account and “wallet” accessed by computing device
33 trading accounts and wallets of other blockchain users
34 transportation provider's trading account and wallet accessed by computing device
35 transit consumer's trading account and wallet accessed by computing device
36 other consumer's trading account and wallet accessed by computing device
37 linking a trading account and wallet to a blockchain (sub-operation)
38 producing a digital fare token (sub-operation)
39 creating other digital tokens (sub-operation)
40 designating fare token producers from token creators (sub-operation)
41 acquiring digital fare tokens by transportation provider or agency (sub-operation)
42 purchasing digital fare tokens from a transit agency (sub-operation)
43 redemption of fare tokens by transit consumer (sub-operation)
44 purchasing digital fare tokens from a non-transit entity or person (sub-operation)
51 transportation or transit vehicle
52 receiver wallet address of a trading account
53 transportation or transit agent's computing device
56 transit consumer's computing device in process of transferring fare token
59 transit zone

### DETAILED DESCRIPTION OF EMBODIMENTS

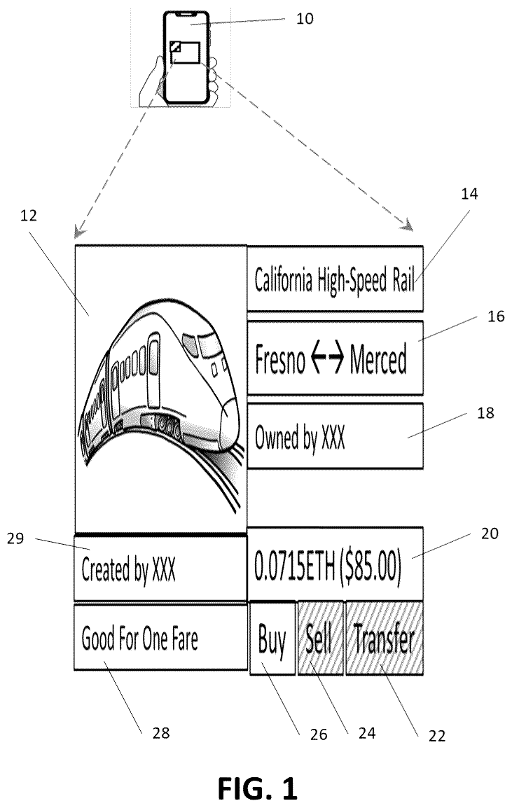

Referring to the drawings, a typical re-circulatable digital fare token created by a non-fungible token algorithm is shown in FIG. 1, containing a uniquely-identified digital composition 12 and viewed and/or listened to from a screen interface of a computing device 10. The fare token further indicates its original creator or producer 29, the producer's website collection 14 where the fare tokens are displayed, and the present owner 18. The indications each are a website hyperlink that when tapped, opens to additional sets of information useful for noting and confirming the validity of the fare token. The Buy, Sell and Transfer touchscreen buttons 26, 24, 22 are either enabled or disabled for tapping depending upon who owns the fare token, and whether he or she has logged on to his or her website-based trading account and digital “wallet”. For example, a fare token owned by a transportation provider or transit agency would have the Buy button 26 enabled when it is put up for sale. The Sell and Transfer 24, 22 buttons are enabled for any owner of the fare token logged on to their respective trading accounts and wallets.

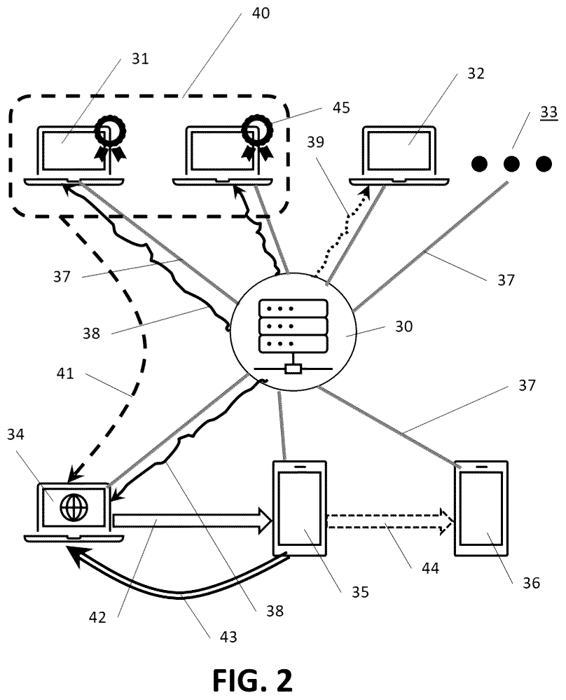

Referring to FIG. 2, the transit agency 34, the fare token producers 31, and consumers 35, 36 interact with each other on the internet by their respective website trading accounts and wallets linked 37 by a common public blockchain 30, forming the circulation environment for the fare tokens. Only the fare token producers 31 designated to be so 40 by the transit agency 34 can produce valid digital fare tokens. In one embodiment, this designation may be done by creating a separate non-fungible token (“NFT”) containing a written agreement to produce fare tokens and issuing the agreement NFT 45 to the producer's trading account 31. This distinguishes fare token producers 31 from other NFT creators or collectors 32, 33 on the public blockchain. In an alternative embodiment, the transit agency itself 34 may be one of the franchises producing the fare tokens 38.

It should be noted that each trading account is identically configured to be capable of creating, transferring, storing, selling and buying fare tokens, whether it belongs to a transit consumer, a fare token producer, or a transit agency. Consequently, the transit agency's “storefront” for the fare tokens appears similar to that of other account owners in the blockchain owning NFTs.

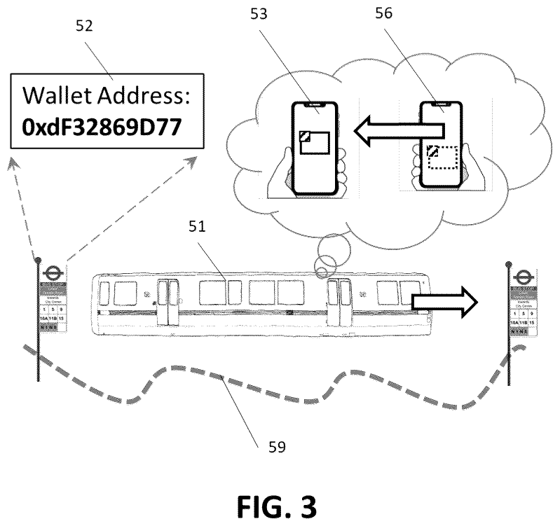

Referring to FIG. 3, the digital fare tokens are sold to transportation consumers to access occupancy, or ride on a vehicle 51 available to provide a paid transportation service within a transit zone made up of a predetermined geographic path and distance 59. When a transportation consumer redeems a fare token for a ride, he or she accesses his or her trading account from an internet-connected computing device upon arrival at the terminal of the transit zone 59, and taps the transfer button on the fare token 22. The consumer finds and enters the transit agency's website-based fare token receiver “wallet address”, which is a sequence of alphanumeric characters 52, as prompted by the trading account's transfer algorithm, thus initiating transfer of the fare token 56 upon boarding the vehicle 51. In one embodiment, the proper transfer of the fare token to the transit agency is facilitated by a transit agent 53.

The transit agency's designation 40 as agreed upon with the fare token producer 31 specifies the fare token's transit zone 16, the selling price 20 which may be in cryptocurrency units, the terms of fare token redemption 28, and the collection 14 where the fare tokens may be stored and be publicly viewable through an internet-connected computing device. The transit agency then specifies the quantity of fare tokens to be produced and acquires 41 the fare tokens from the producers 31. This is accomplished by an electronic transfer similarly involving the receiver wallet address of the transit agency's trading account. Upon acquisition, the transit agency accesses an executable electronic form within his or her trading account that enables the fare tokens to be put up for sale, with pricing reflective of value specific to a transit zone. A transit agency may have more than one transit zones in its transit network. Thus in one embodiment, two fare tokens produced for two different transit zones can differ in specifications, such as in designated producer and pricing.

Upon obtaining agreement 45 from transportation provider 34, a fare token producer 31 creates a digitized artistic composition of his or her design method and preference 12 that can be viewed or listened to using a computing device 10. The producer then completes within his or her trading account an executable electronic form that enables token creation, with predetermined entries 12, 16, 28, 14, namely: a field for attaching the artistic composition 12, each of data entry fields for: transit zone 16, terms of fare token redemption 28, and computing device-viewable collection 14 to store the fare tokens. He or she then produces them 38 in quantities specified by the transportation provider, and transfers them 41 to the transportation provider's trading account 34.

In order to purchase the fare tokens, a transportation consumer needs to set up a trading account and digital wallet that is linked in common by a public blockchain with the transportation provider. He or she deposits in the wallet money in the amount sufficient for fare token payments. He or she then searches through the internet fare tokens that are for sale and that indicate the transit zone of their desired destination. Prior to purchasing, he or she can confirm that a fare token is valid by noting that the fare token is owned by the transportation provider. Alternatively, referring again to FIG. 2, prior to purchasing 44 from a non-transit entity 35, a transportation consumer 36 can confirm that a fare token is valid by noting that it was produced by a producer designated by the transportation provider.

The fare token's re-circulatable operation that this invention teaches is referred to in FIG. 2, where the transportation or transit consumer 35 purchases the fare token 42 from a transportation provider 34. Upon redeeming the fare token for transportation service, the transportation consumer's fare token ownership is transferred back 43 to the transportation provider 34. Once again, this fare token is available to be sold.

### Advantages

To the transportation provider, this innovative fare operation can have a low barrier cost to implementation. With non-fungible token (“NFT”) technology, it may be demonstrated that any person or entity intending to provide a paid transportation service can set up a trading account with an internet platform hosting a public blockchain, such as online at OpenSea.io or Rarible.com. to distribute fare tokens or tickets. He or she can create an NFT ticket or token specified for a vehicle travel of a predetermined path and distance, and put it up for sale at a predetermined price. Alternatively, that transportation provider can designate someone else registered on the same internet platform to create the NFT on his or her behalf, to be sold as their ride ticket or token. The act of designating can be simply creating a separate NFT containing a written agreement to produce fare tokens, and transferring it to the producer's trading account. In both cases, the fare token operating costs to the transportation provider are minimal.

This transportation fare method induces participation by a business or franchise as it presents an opportunity to advertise his or her business to a wider audience of transit consumers. Additionally, a built-in benefit available to NFT creators on the public blockchain, is receiving a royalty or a percentage of each selling price, regardless of how many times a producer's fare token is resold. For fare tokens designed and operated to be recirculating, this presents an opportunity to the producer to earn a stream of income.

Aside from the transportation service, this method of operation induces consumer demand as it creates another value proposition of the fare token to the transit consumer. For example, if the fare tokens are produced by a photography franchise, this presents an opportunity to own a “limited-edition” artwork by an artist with a social following. In another example, if the fare tokens are produced by a restaurant or convenience store franchise near a train station, it can offer a discount on a transit consumer's food purchased prior to redeeming the fare token for a train ride.

Finally, given the ownable digital asset nature of NFT, any current owner of the fare token—the producer, the transit agency, the transit consumer can participate and potentially benefit in the market forces driving the NFT fare token's value. The digital fare token may be traded in cryptocurrency, which itself fluctuates more in value as compared with a stable fiat money. Moreover, if an emerging transit system meets construction schedule in one phase and suffer delays in another, or if an artist's popularity increases on one year, and lose social following on the next, such factors will affect the supply and demand, hence the market value of the fare token.

### CONCLUSION, RAMIFICATIONS, AND SCOPE

As previously noted, the fare method that this invention teaches can continue to support the emerging public transit system after it is fully constructed, due to the advantages of blockchain technology. As such, this novel method may also be introduced as a ride ticketing system on a blockchain in existing transit operations such as in Los Angeles Metro (LACMTA) or in Southern California Regional Rail Authority (Metrolink) to complement their existing fare systems.

Additionally, where previous physical tokens or “subway tokens” have been informally allowed by a transit agency to be retained in transportation consumers' possession for indefinite periods due to a variety of reasons (e.g. lost or misplaced, discontinued tokens or transit zones, etc.), these NFT tokens may be legitimately owned by the public. The consumer may choose and be allowed to not redeem them for transportation, and instead exercise ownership rights to the NFT due to the value of the digital composition embedded within.

Although the description above contains many references to specific versions and aspects of the invention, this circumstance should not be construed as limiting the scope of the invention but as merely providing illustrations of some of the presently preferred embodiments of this invention. For example, a fare token can have a title in the product with other words such as “ticket” or “pass”; a transit zone can be defined by geographic points; a terminal can be equipped with a non-human, computer NFT agent. Thus, the scope of this invention should be determined by the appended claims and their legal equivalents, rather than by the examples given in the descriptions above.

I claim:

1. A demand-inducing public transportation fare method comprising:
producing digital fare tokens created by a non-fungible token (NFT) algorithm in a computer, said fare tokens to be sold to a transportation consumer for the purpose of accessing occupancy on a vehicle available to provide a paid transportation service within a transit zone of a transit network, said transit zone comprising a predetermined geographic path and distance;
interacting among a plurality of digital token creators' and consumers' internet-based trading accounts linked by a public blockchain, said trading accounts comprising the environment for producing, transferring, storing, selling and buying said fare tokens; and
selecting and designating, among a plurality of digital token creators, at least one independent producer to produce said digital fare tokens, said producer having a social following by a transportation consumer,
whereby said fare method can be operated over any condition said transit zone may be found, including: planned but not yet constructed, constructed and in service, and constructed but temporarily out-of-service.

2. The method of claim 1, wherein said fare tokens are re-circulatable, whereby said fare tokens after redemption for service by a first transportation consumer can be resold to a second transportation consumer, and in subsequent redemptions.

3. The method of claim 1, wherein said fare tokens are traded using any payment selected from cryptocurrency and fiat money.

4. The method of claim 1, wherein each of said fare tokens contain and display a uniquely-identifiable digital composition.

5. The method of claim 4, wherein said digital composition is designed in a producer's method and preference, and is viewable and audible from an interface of a computing device.

6. The method of claim 1, wherein each of said fare tokens at all times has a set of indications comprising: the original producer, the producer's collection where said fare tokens are displayed, the present owner, and history of ownership by previous owners, wherein each of said indication is a website hyperlink that when tapped, leads to information that can confirm the validity of said fare token.

7. The method of claim 1, wherein said fare tokens are produced in a computer by at least one of any independently-owned franchises selected from: an artist, an agency and a business entity.

8. The method of claim 1, wherein said fare token producers are each paid a percentage of purchase price in the range of five to ten percent whenever said fare token produced by producer is sold, using any payment selected from cryptocurrency and fiat money.

9. The method of claim 1, wherein each trading account is identically capable of creating, transferring, selling and buying digital tokens.

10. The method of claim 9, wherein said trading account for fare tokens is an internet webpage comprising: a digital wallet-enabled logon, a receiver wallet address comprising a predetermined sequence of alphanumeric characters, and non-fungible token executable electronic forms for creating and selling fare tokens.

11. The method of claim 1, wherein said fare token is transferred from a first computer-based trading account to a second trading account by entering on a screen prompt a receiver wallet address and a touchscreen button that when tapped, executes an algorithm that transfers ownership of the fare token.

12. The method of claim 1, wherein said fare tokens are transferred to any entity along with a plurality of ownership rights granted, including: the right to redeem said fare tokens for transportation as said transit zone vehicle becomes available for service, the right to sell ownership of said fare tokens to another entity, and the right to retain ownership of said fare tokens indefinitely.

13. The method of claim 1, wherein said redemption of fare tokens is a set of actions comprising: locating the terminal of said transit zone, determining whether a vehicle is available for service, accessing said fare token within transportation consumer's trading account, determining the transportation provider's receiver wallet address prompted by said trading account's transfer algorithm, and tapping a touchscreen button on the fare token to transfer ownership from transportation consumer to transportation provider upon boarding said vehicle.

14. The method of claim 1, wherein said designating fare token producers is a set of actions comprising: creating a digitally-recorded written agreement naming a digital token creator to produce fare tokens, and transferring said agreement to creator's trading account.

15. The method of claim 14, further comprising: for a fare token design, determining the transit zone, determining the selling price, determining the terms of fare token redemption, determining the collection where said fare tokens may be stored and be publicly viewable through an internet-connected computing device; determining the quantity of fare tokens to be produced; and acquiring said fare tokens from token producers.

16. The method of claim 1, wherein said producing of digital fare tokens is a set of actions comprising: obtaining from transportation provider an agreement to be a fare token producer to said transportation provider; creating a digital composition in said producer's method and preference; completing within producer's trading account an executable electronic form with predetermined entries comprising: a field for attaching said digital composition, each of data entry fields for: transit zone, terms of fare token redemption, and computing device-viewable collection to store said fare tokens; mass-producing said fare tokens in quantity specified by transportation provider; and transferring said fare tokens to transportation provider's trading account.

17. The method of claim 1, wherein said selling of fare tokens is a set of actions comprising: posting for sale fare tokens selected from the group consisting: 1) those acquired from a designated producer, and 2) those previously collected from transportation consumer redemptions; and setting and adjusting fare token pricing using any payment selected from cryptocurrency and fiat money.

18. The method of claim 17, further comprising a decision of fare token selling price to place greater value in any benefit selected from: a transportation service, and a producer's digital composition and social following.

19. The method of claim 1, wherein said buying of fare tokens is a set of actions comprising: requiring transportation consumer to set up a trading account linked by the same public blockchain as transportation provider; enabling searching by an internet-connected computer fare tokens that are for sale and that indicate transit zone of desired destination; allowing confirmation of a fare token as valid if, prior to purchasing, has any indication as selected from: 1) owned by said transportation provider, and 2) produced by producer designated by said transportation provider; and facilitating payment for said fare tokens.

20. The method of claim 1, wherein said fare tokens are referred to with other words selected from: “tickets” and “passes”.
